(19) United States
(12) Patent Application Publication
(10) Pub. No.: US 2016/0034977 A1
(43) Pub. Date: Feb. 4, 2016

(54) SYSTEM AND METHOD FOR EMBEDDED SEARCH WITHIN MESSAGING APPLICATIONS

(71) Applicant: YAHOO! INC., Sunnyvale, CA (US)

(72) Inventors: Mayukh Bhaowal, Redwood City, CA (US); Yaroslav Reptak, Fort Lee, NJ (US); Thanawat Kaewka, Sunnyvale, CA (US)

(21) Appl. No.: 14/449,801

(22) Filed: Aug. 1, 2014

(51) Int. Cl. G06Q 30/02; G06F 17/30; H04L 12/58

(52) U.S. Cl. CPC G06Q 30/0277; H04L 51/046; G06F 17/30864

(57) ABSTRACT

Disclosed is a system and method for integrating search capabilities with message composition functionality. The present disclosure provides an intersection between messaging and search by enabling a user to search for content from differing entities and resources from within the body of a message compose window. The disclosed systems and methods enable a user, from within a messaging application or platform, to perform a search for content, view the results, and select and embed the desired result within the message in a rich format.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present disclosure relates generally to messaging applications having search capabilities and more specifically, towards systems and methods for inline embedding of content during composition of a message.

### RELATED ART

Electronic mail (“email”) and other forms of messaging applications have become omnipresent in everyday use as larger numbers of people are able to access the Internet from an array of devices. Such messaging applications provide an effective way fur individuals to communicate more efficiently with each other. In addition to text being included in the messages, messages can also include other types of content, including, for example, images, videos, audio and the like. However, conventional techniques for including such content in a message are limited. That is, if a user desires to include content, for example, an image, in a message, the user must either attach the image by loading the previously stored image from the user's local device, or if the image is located at an Internet location, the user must first switch to a separate search program to locate the content and copy the content or content link, then paste the copied information after switching back to the messaging program.

### SUMMARY

The present disclosure describes systems and methods for integrating search capabilities within message composition functionality. The present disclosure provides an intersection between messaging (email or instant messaging or text messaging, as examples) and search by enabling a user to search for content from differing entities and resources from within a messaging application. The disclosed systems and methods enable a user, from within a messaging application or platform, to perform a search for content, view the results, and select and embed the desired result within the message in a rich format. That is, according to some embodiments, search functionality for searching an array of local and remote sources (e.g., Internet) are embedded within a messaging application. For example, from within Yahoo! Mail, a user is afforded the ability to search for content using a search engine. As discussed herein, the search ability may be available from within the body of a message compose screen/window, from within a toolbar of the messaging application/platform, within a side-panel or other panel, tile, rail, slidesheet or window affiliated with a messaging program, or via a command entered within the body of the message by the composing user. Therefore, the user can easily embed a desired content item(s) within a message without having to diverge from the messaging platform/application/program.

Conventional techniques require a user to contextually switch, for example, from a messaging program to a search program, then back again to complete the message. The disclosed systems and methods eliminate these shortcomings in the art. Indeed, conventional systems simply allow a user to copy and paste either the content and/or the content's URL. These additional steps of switching programs, and copying and pasting are eliminated as the present disclosure enables searching and embedding desired results all from within a single platform. Indeed, there is no longer a need to copy or cut, and paste content and/or content's URLs, as the content can be embedded directly from the content's source all within the messaging application/program/platform.

In accordance with one or more embodiments, a method is disclosed which includes receiving, at a computing device, message input from a user in a messaging application, said message input corresponding to composition of a message via the messaging application; detecting, via the computing device, a search query from said message input, said search query comprising a search request; determining, via the computing device, a category associated with said search; searching, via the computing device, for content on a network based on said search. query, said search initiated by the messaging application to search a network accessible resource associated with said category; displaying, via the computing device, search results within said messaging application in association with said message; receiving, at the computing device, a user selection of a result from said search results; and embedding, via the computing device, said selected result in said message, said embedding occurring automatically upon said selection by the user.

In accordance with some embodiments, a method is disclosed which includes receiving, at a computing device, a search request from a user upon said user composing a message in a messaging application, said search request identifying a content type and category associated with a network accessible resource; causing, via the computing device, the network accessible resource to be searched based on said search request; causing, via the computing device, search results to be displayed to the user within the messaging application displayed on the user's device; receiving, at the computing device, a selection from the user of a result from said search results; causing, via the computing device, an advertisement platform to be searched based on the selected result; receiving, at the computing device, an advertisement associated with said selected result; and causing, via the computing device, said selected result and the advertisement to be displayed to the user within the messaging application displayed on the, user device.

In accordance with some embodiments, a method is disclosed which includes receiving, at a computing device, a search request from a user upon said user composing a message in a messaging application concurrently displayed on a user device, said search request identifying a content type and category locatable on a network accessible resource; causing, via the computing device, a search for a search result and an advertisement based on the search request; receiving, at the computing device, said search result and said advertisement; and causing, via the computing device, the search result and the advertisement to be displayed to the user within the messaging application displayed on the user device.

In accordance with one or more embodiments, a non-transitory computer-readable storage medium is provided, the computer-readable storage medium tangibly storing thereon, or having tangibly encoded thereon, computer readable instructions that when executed cause at least one processor to perform a method for inline embedding of content during composition of a message.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code to implement functionality in accordance with one or n more such embodiments is embodied in, by and/or on a computer-readable medium.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a schematic diagram illustrating an example of a network within which the systems and methods disclosed herein could be implemented according to some embodiments of the present disclosure;

FIG. 2 depicts is a schematic diagram illustrating a client device in accordance with some embodiments of the present disclosure;

FIG. 3 is a schematic block diagram illustrating components of a system in accordance with embodiments of the present disclosure;

FIGS. 4A-4B are a flowcharts illustrating steps performed in accordance with some embodiments of the present disclosure

FIGS. 5A-5D illustrate a non-limiting example in accordance with embodiments of the present disclosure with reference to FIGS. 3 and 4A;

FIGS. 6A-6D illustrates a non-limiting example in accordance with embodiments of the present disclosure with reference to FIGS. 3 and 4B;

FIG. 7 is a flowchart illustrating steps performed in accordance with some embodiments of the present disclosure; and

FIG. 8 is a block diagram illustrating architecture of a hardware device in accordance with one or more embodiments of the present disclosure.

### DESCRIPTION OF EMBODIMENTS

The present disclosure will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

These computer program instructions can be provided to a processor of a general purpose computer, special purpose computer, ASIC, or other programmable data processing apparatus, such that the instructions, which execute via the processor of the computer or other programmable data processing apparatus, implement the functions/acts specified in the block diagrams or operational block or blocks.

For the purposes of this disclosure a computer readable medium (or computer-readable storage medium/media) stores computer data, which data can include computer program code (or computer-executable instructions) that is executable by a computer, in machine readable form, By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. Various types of devices may, for example, be made available to provide an interoperable capability tier differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology. may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RE or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For purposes of this disclosure, a client (or consumer or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a laptop computer, a set top box, a wearable computer, an integrated device combining various features, such as features of the forgoing devices, or the like.

A client device may vary in terms of capabilities or features. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

A client device may include or may execute a variety of operating systems, including a personal computer operating system, such as a Windows®, iOS® or Linux®, or a mobile operating system, such as iOS®, Android®, or Windows Mobile®, or the like. A client device may include or may execute a variety of possible applications, such as a client software application enabling communication with other devices, such as communicating one or more messages, such as via email, short message service (SMS), or multimedia message service (MMS), including via a network, such as a social network, including, for example, Facebook®, LinkedIn®, Twitter®, Flickr®, or Google+®, Instagram™, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally stored or streamed video, or games (such as fantasy sports leagues). The foregoing is provided to illustrate that claimed subject matter is intended to include a wide range of possible features or capabilities.

The principles described herein may be embodied in many diff rent forms. Modern active messaging users, such as email, instant messaging, SMS and MMS users, and the like, receive a large number of messages as usages for messaging have become omnipresent. Indeed, electronic messaging usages are on the rise as they provide a powerful means of communicating content to a targeted audience, Currently, if a user desires to compose a message where the message includes external content, the user will be required to perform a multitude of steps via separate application programs in order to compose a complete message. For example, if a user is composing a message and desires to insert an image, the user will have to contextually switch from the messaging application to a search program, then back again to complete the message. Conventional techniques require the user to either copy and paste either the content and/or the content's URL. Indeed, there currently exists no program or application platform that enables searching and embedding content within a screen or window via which a message is composed (a compose screen/window).

The disclosed systems and methods remedy the failings in the art through an integration of different software applications so that users can create, view, edit and generally manage information associated with one application while working within another different application. That is, the disclosed systems and methods enable users the ability to search different entities right within the body of a message compose window, view results and select and embed the search results within the message in rich format making it easy to consume for the recipient. The core problem solved by the present disclosure is being able to frictionlessly search and embed content into a message during composition of such message.

For example, Bob wants to share a dancing meme with his friend Jim. Currently, there is no way to search for the meme from within a messaging application Bob is using to communicate with Jim. Additionally, the only way to locate the meme is for Bob to perform a web search outside the message application, then copy and paste the link of the meme in the message. Indeed, from current search programs, there are currently no capabilities that enable the embedding of such content within a message compose window of separate messaging program. Thus, Bob will have to contextually switch from composing the message, to searching the internet, whereby Bob will then, after locating the desired meme, copy and paste the link back in the message by contextually switching back to the message application.

Indeed, search and messaging applications, as well as their web-based application versions, remain independent from, and unintegrated with, each other. Thus, users are required to manually toggle from one application to another application when needing information from different applications. In another example, while working within an e-mail application window, a user has to move to another application window to work with a search application, e.g., in order to access search results. Similarly, the user has to then move back to the e-mail window to continue working with the e-mail application in order to include the information from the search. For some users, changing back and forth among application windows may be required many times during a given user session, which can be a cumbersome and certainly interruptive process.

The present disclosure describes systems and methods for integrating search capabilities within message composition functionality. The present disclosure provides an intersection between messaging and search by enabling a user to search for content from differing entities and resources from within the body of a message compose window. As discussed in more detail below, the entities/resources providing the content for inclusion in the message can be remote and/or local.

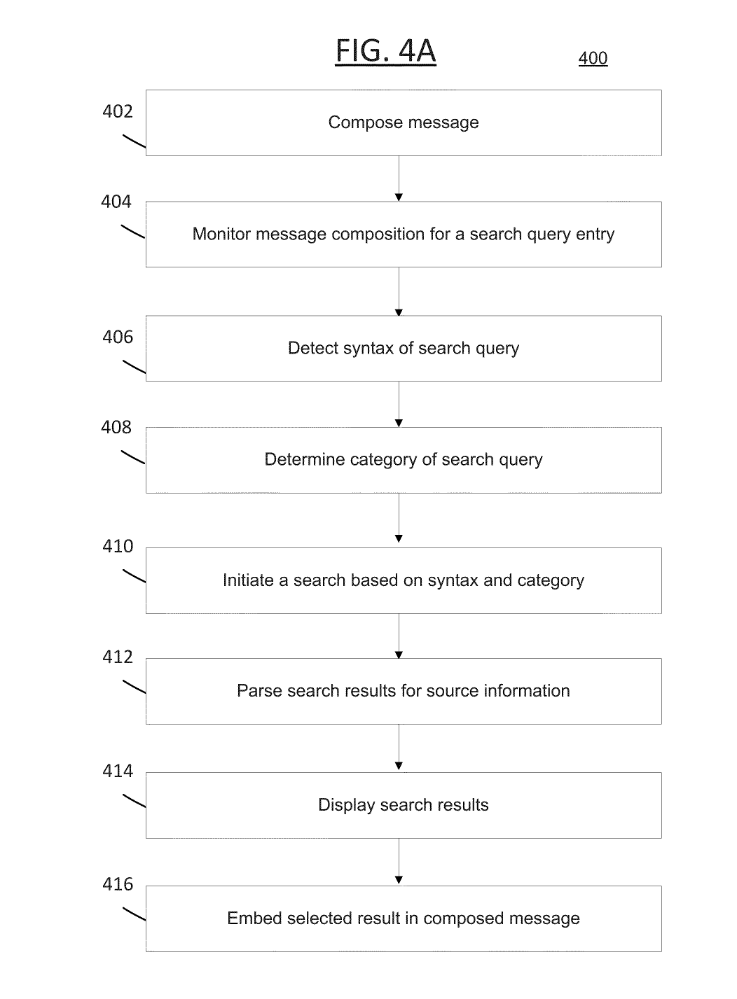

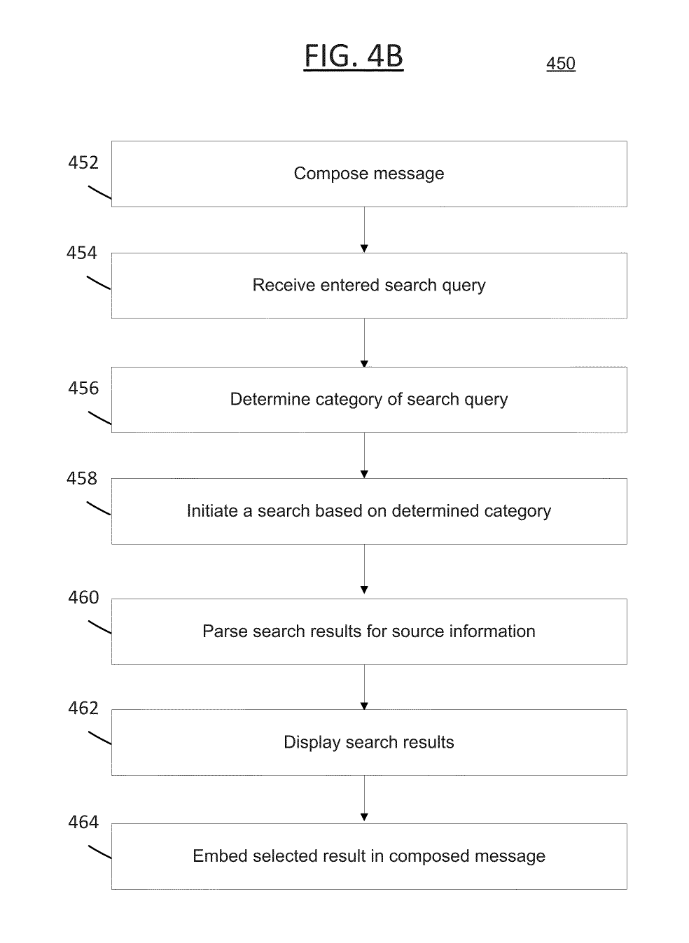

According to some embodiments, the content sources are located on a network, such as the Internet. The disclosed systems and methods enable a user, from within a messaging application or platform, perform a search for content, view the results, and select and embed the desired result within the message in a rich format. That is, according to some embodiments, search functionality for searching an array of local and remote sources (e.g., Internet) are embedded within a messaging application. For email as an example, from within an electronic mail product such as Yahoo! Mail®, a user is afforded the ability to search for content using a search engine. According to some embodiments, as discussed in more detail below, for example in FIGS. 4-6, the search ability may be available from within the body of a message compose window, from within a toolbar of the messaging application/platform, within a side-panel or other panel, tile, rail, slidesheet or window affiliated with a messaging program, or via a command entered by the composing user. Therefore, the user can easily embed a desired content item(s) within a message without having to diverge from the messaging platform/application/program.

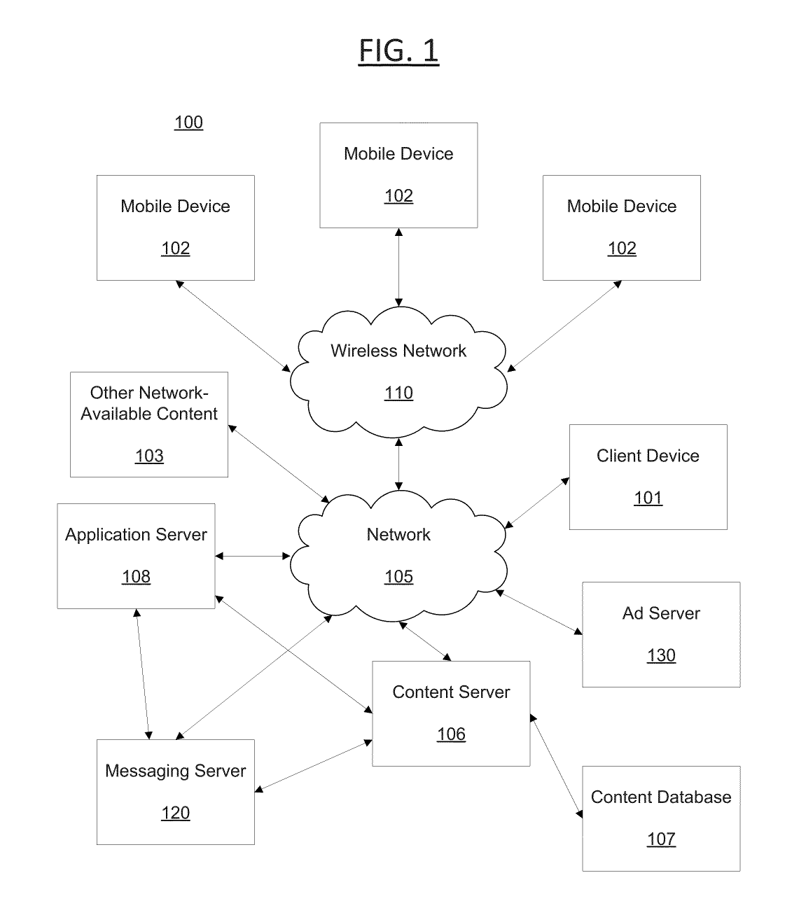

Certain embodiments will now be described in greater detail with reference to the figures. In general, with reference to FIG. 1, a system 100 in accordance with an embodiment of the present disclosure is shown. FIG. 1 shows components of a general environment in which the systems and methods discussed herein may be practiced. Not all the components may be required to practice the disclosure, and variations in the arrangement and type of the components (or order of steps) may be made without departing from the spirit or scope of the disclosure.

As shown, system 100 of FIG. 1 includes local area networks (“LANs”)/wide area networks (“WANs”)—network 105, wireless network 110, mobile devices (client devices) 102 and client device 101. FIG. 1 additionally includes a variety of servers, such as content server 106, application (or “App”) server 108, messaging server 120 and advertising (“ad”) server 130.

One embodiment of mobile devices 102-103 is described in more detail below. Generally, however, mobile devices 102 may include virtually any portable computing device capable of receiving and sending a message over a network, such as network 105, wireless network 110, or the like.

Mobile devices 102 may also be described generally as client devices that are configured to be portable. Thus, mobile devices 102 may include virtually any portable computing device capable of connecting to another computing device and receiving information. Such devices include multi-touch and portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, and the like. As such, mobile devices 102 typically range widely in terms of capabilities and features. For example, a cell phone may have a numeric keypad and a few lines of monochrome LCD display on which only text may be displayed. In another example, a web-enabled mobile device may have a touch sensitive screen, a stylus, and several lines of color LCD display in which both text and graphics may be displayed.

A web-enabled mobile device may include a browser application that is configured to receive and to send web pages, web-based messages, and the like. The browser application may be configured to receive and display graphics, text, multimedia, and the like, employing virtually any web based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message.

Mobile devices 102 also may include at least one client application that is configured to receive content from another computing device. The client application may include a capability to provide and receive textual content, graphical content, audio content, and the like. The client application may further provide information that identifies itself, including a type, capability, name, and the like. In one embodiment, mobile devices 102 may uniquely identify themselves through any of a variety of mechanisms, including a phone number, Mobile Identification Number (MIN), an electronic serial number (ESN), or other mobile device identifier.

In some embodiments, mobile devices 102 may also communicate with non-mobile client devices, such as client device 101, or the like. In one embodiment, such communications may include sending and/or receiving messages, share photographs, audio clips, video clips, or any of a variety of other forms of communications. Client device 101 may include virtually any computing device capable of communicating over a network to send and receive information. The set of such devices may include devices that typically connect using a wired or wireless communications medium such as personal computers, multiprocessor systems, microprocessor-based or programmable consumer electronics, network PCs, or the like. Thus, client device 101 may also have differing capabilities for displaying navigable views of information.

Client devices 101-102 computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Wireless network 110 is configured to couple mobile devices 102 and its components with network 105. Wireless network 110 may include any of a variety of wireless sub-networks that may further overlay stand-alone ad-hoc networks, and the like, to provide an infrastructure-oriented connection for mobile devices 102. Such sub-networks may include mesh networks, Wireless LAN (WLAN) networks, cellular networks, and the like.

Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly. Wireless network 110 may further employ a plurality of access technologies including 2nd (2G), 3rd (3G), and/or 4th (4G) generation radio access for cellular systems, WLAN, Wireless Router (WR) mesh, and the like. Access technologies such as 2G, 3G, 4G and future access networks may enable wide area coverage for mobile devices, such as mobile devices 102 with various degrees of mobility. For example, wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. In essence, wireless network 110 may include virtually any wireless communication mechanism by which information may travel between mobile device s 102 and another computing device, network, and the like.

Network 105 is configured to couple content server 106, application server 108, or the like, with other computing devices, including, client device 101, and through wireless network 110 to mobile devices 102. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between content servers 106, application server 108, client device 101, other content or information available on or via the network 103, and/or other computing devices.

Within the communications networks utilized or understood to be applicable to the present disclosure, such networks will employ various protocols that are used for communication over the network. Signal packets communicated via a network, such as a network of participating digital communication networks, may be compatible with or compliant with one or more protocols. Signaling formats or protocols employed may include, for example, TCP/IP, UDP, DECnet, NetBEUI, IPX, APPLETALK™, or the like. Versions of the Internet Protocol (IP) may include IPv4 or IPv6. The Internet refers to a decentralized global network of networks. The Internet includes local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

According to some embodiments, the present disclosure may also be utilized within a social networking site. A social network refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. In some embodiments, multi-modal communications may occur between members of the social network. Individuals within one or more social networks may interact or communication with other members of a social network via a variety of devices. Multi-modal communication technologies refers to a set of technologies that permit interoperable communication across multiple devices or platforms, such as cell phones, smart phones, tablet computing devices, personal computers, televisions, set-top boxes, SMS/MMS, email, instant messenger clients, forums, social networking sites, or the like.

In some embodiments, the disclosed networks 110 and/or 105 may comprise a content distribution network(s). A “content delivery network” or “content distribution network” (CDN) generally refers to a distributed content delivery system that comprises a collection of computers or computing devices linked by a network or networks A CDN may employ software, systems, protocols or techniques to facilitate various services, such as storage, caching, communication of content, or streaming media or applications A CDN may also enable an entity to operate or manage another's site infrastructure, in whole or in part.

The content server 106 may include a device that includes a configuration to provide content via a network to another device. A content server 106 may, for example, host a site, such as a messaging/email platform or social networking site, or a personal user site (such as a blog, vlog, online dating site, and the like). A content server 106 may also host a variety of other sites, including, but not limited to business sites, educational sites, dictionary sites, encyclopedia sites, wikis, financial sites, government sites, and the like. Devices that may operate as content server 106 include personal computers desktop computers, multiprocessor systems, microprocessor-based or programmable consumer electronics, network PCs, servers, and the like.

Content server 106 can further provide a variety of services that include, but are not limited to, email services, photo services, web services, third-party services, audio services, video services, instant messaging (IM) services, SMS services, MMS services, FTP services, voice over IP (VOIP) services, or the like. Such services, for example the email services and email platform, can be provided via the messaging server 120. Examples of content may include images, text, audio, video, or the like, which may be processed in the form of physical signals, such as electrical signals, for example, or may be stored in memory, as physical states, for example.

An ad server 130 comprises a server or ad platform that stores online advertisements for presentation to users. “Ad serving” refers to methods used to place online advertisements on websites, in applications, or other places where users are more likely to see them, such as during an online session or during computing platform use, for example. Various monetization techniques or models may be used in connection with sponsored advertising, including advertising associated with user. Such sponsored advertising includes monetization techniques including sponsored search advertising, non-sponsored search advertising, guaranteed and non-guaranteed delivery advertising, ad networks/exchanges, ad targeting, ad serving and ad analytics.

For example, a process of buying or selling online advertisements may involve a number of different entities, including advertisers, publishers, agencies, networks, or developers. To simplify this process, organization systems called “ad exchanges” or ad platforms may associate advertisers or publishers, such as via a platform to facilitate buying or selling of online advertisement inventory from multiple ad networks. “Ad networks” refers to aggregation of ad space supply from publishers, such as for provision en masse to advertisers. For web portals like Yahoo!®, advertisements may be displayed on web pages resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users.

One approach to presenting targeted advertisements includes employing demographic characteristics (e.g., age, income, sex, occupation, etc.) for predicting user behavior, such as by group. Advertisements may be presented to users in a targeted audience based at least in part upon predicted user behavior(s). Another approach includes profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users. During presentation of advertisements, a presentation system may collect descriptive content about types of advertisements presented to users. A broad range of descriptive content may be gathered, including content specific to an advertising presentation system. Advertising analytics gathered may be transmitted to locations remote to an advertising presentation system for storage or for further evaluation. Where advertising analytics transmittal is not immediately available, gathered advertising analytics may be stored by an advertising presentation system until transmittal of those advertising analytics becomes available.

Servers 106, 108, 120 and 130 may be capable of sending or receiving signals, such as via a wired or wireless network, or may be capable of processing or storing signals, such as in memory as physical memory states. Devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally, a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

In an embodiment, users are able to access services provided by servers 106, 108, 120 and/or 130. This may include in a non-limiting example, email servers, social networking services servers, SMS servers, IM servers, MMS servers, exchange servers, and all other known or to be known types of messaging servers, in addition to, photo-sharing services servers, and travel services servers, via the network 105 using their various devices 101-102. In some embodiments, applications, such as a photo-sharing or viewing application (e.g., Flickr®, Instagram®, and the like), can be hosted by the application server 108. Thus, the application server 108 can store various types of applications and application related information including application data and user profile information. In another example, messaging server 120 can host email applications; therefore, the messaging server 120 can store various types of applications and application related information including email application data and user profile information. It should also be understood that content server 106 can also store various types of data related to the content and services provided by content server 106 in an associated content database 107, as discussed in more detail below. Embodiments exist where the network 105 is also coupled with/connected to a Trusted Search Server (TSS) which can be utilized to render content in accordance with the embodiments discussed herein.

Moreover, although FIG. 1 illustrates servers 106, 108, 120 and 130 as single computing devices, respectively, the disclosure is not so limited. For example, one or more functions of servers 106, 108, 120 and/or 130 may be distributed across one or more distinct computing devices. Moreover, in one embodiment, servers 106, 108, 120 and/or 130 may be integrated into a single computing device, without departing from the scope of the present disclosure.

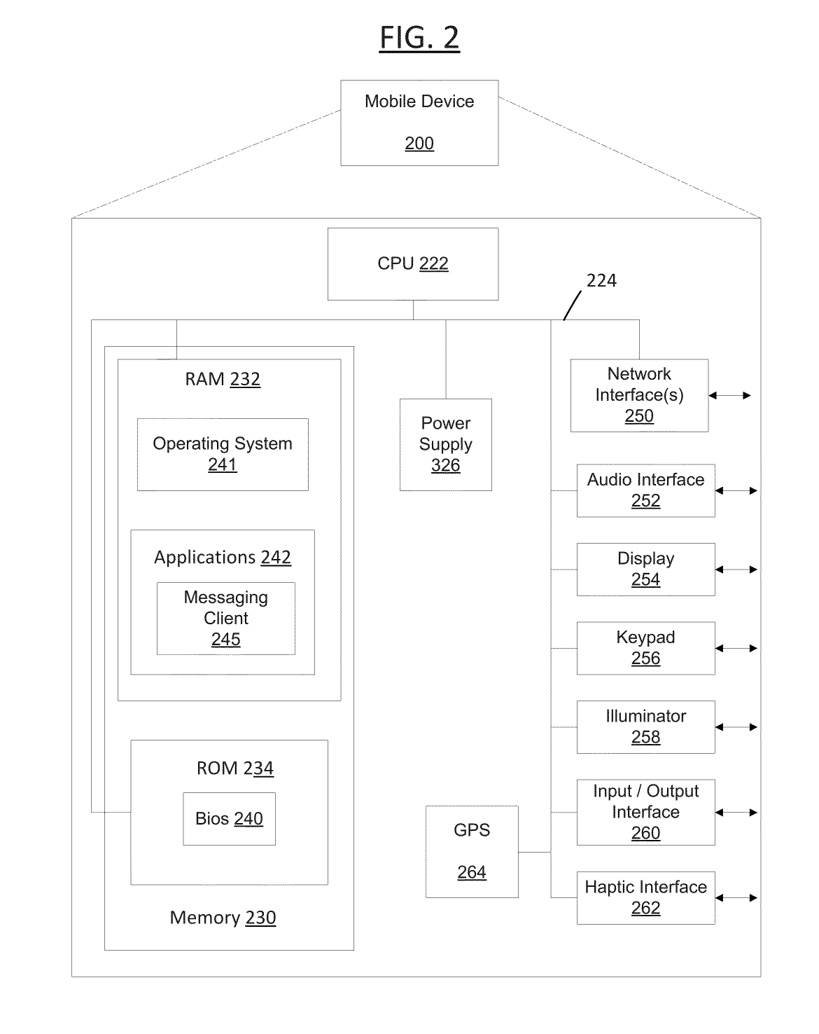

FIG. 2 is a schematic diagram illustrating a client device showing an example embodiment of a client device that may be used within the present disclosure. Client device 200 may include many more or less components than those shown in FIG. 2. However, the components shown are sufficient to disclose an illustrative embodiment for implementing the present disclosure. Client device 200 may represent, for example, client devices discussed above in relation to FIG. 1.

As shown in the figure, Client device 200 includes a processing unit (CPU) 222 in communication with a mass memory 230 via a bus 224. Client device 200 also includes a power supply 226, one or more network interfaces 250, an audio interface 252, a display 254, a keypad 256, an illuminator 258, an input/output interface 260, a haptic interface 262, and an optional global positioning systems (GPS) receiver 264. Power supply 226 provides power to Client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling Client device 200 to one or more networks, and is constructed for use with one or more communication protocols and technologies including, but not limited to, global system for Client communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2, Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate client device 200 in a particular way when the Client device 200 receives a communication from another user.

Optional GPS transceiver 264 can determine the physical coordinates of Client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of Client device 200 on the surface of the Earth. It is understood that under different conditions, GPS transceiver 264 can determine a physical location within millimeters for Client device 200; and in other cases, the determined physical location may be less precise, such as within a meter or significantly greater distances. In one embodiment, however, Client device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of Client device 200. The mass memory also stores an operating system 241 for controlling the operation of Client device 200. It will be appreciated that this component may include a general purpose operating system such as a version of UNIX, or LINUX™, or a specialized client communication operating system such as Windows Client™, or the Symbian® operating system. The operating system may include, or interface with a Java virtual machine module that enables control of hardware components and/or operating system operations via Java application programs.

Memory 230 further includes one or more data stores, which can be utilized by Client device 200 to store, among other things, applications 242 and/o other data. For example, data stores may be employed to store information that describes various capabilities of Client device 200. The information may then be provided to another device based on any of a variety of events, including being sent as part of a header during a communication, sent upon request, or the like. At least a portion of the capability information may also be stored on a disk drive or other storage medium (not shown) within Client device 300.

Applications 242 may include computer executable instructions which, when executed by Client device 200, transmit, receive, and/or otherwise process audio, video, images, and enable telecommunication with another user of another client device. Other examples of application programs include calendars, browsers, contact managers, task managers, transcoders, database programs, word processing programs, security applications, spreadsheet programs, games, search programs, and so forth. Applications 242 may further include messaging client 245 that is configured to send, to receive, and/or to otherwise process messages using email, SMS, MMS, IM, VOIP, and/or any of a variety of other messaging communication protocols. Although a single messaging client 245 is illustrated it should be clear that multiple messaging clients may be employed. For example, one messaging client may be configured to manage email messages, where another messaging client manages SMS messages, and yet another messaging client is configured to manage serving advertisements, IMs, or the like.

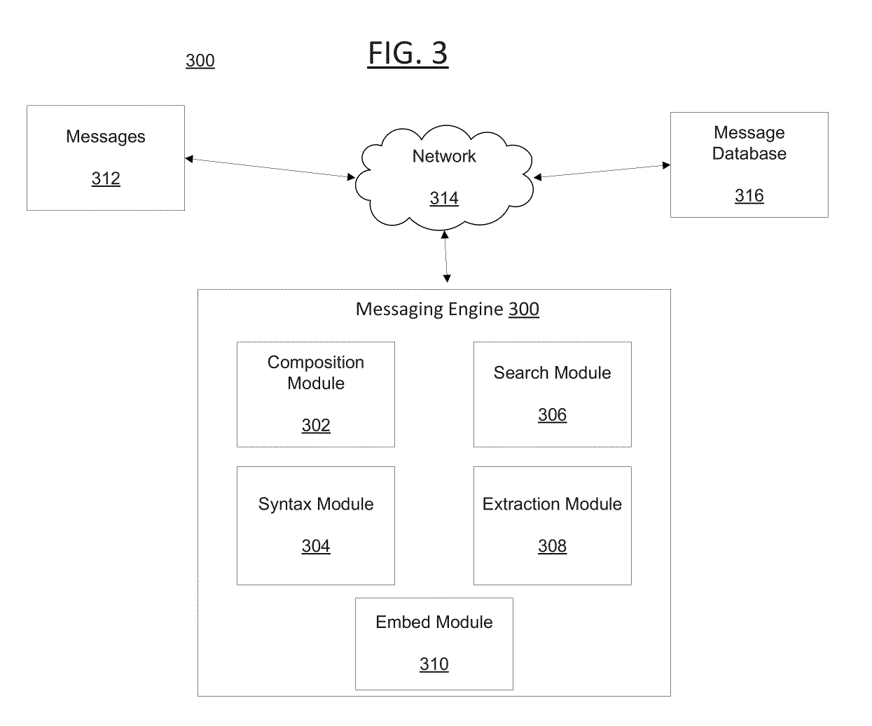

Having described the components of the general architecture employed within the disclosed systems and methods, the components' general operation with respect to the disclosed systems and methods will now be described with respect to FIGS. 3-8.

FIG. 3 is a block diagram illustrating the components for performing the systems and methods discussed herein. FIG. 3 includes a plurality of messages 312, a network 314, a messaging engine 300 and a database 316 for storing information related to the messages and search information. The message engine 300 could be hosted by a web server, content provider, email service provider, ad server, a user's computing device, or any combination thereof. The messages 312 can be any type of message. Examples of such messages 312 can include email messages, HTML forms SMS/MMS messages, Skype® messages, Twitter® messages and other social messages, comments to an article or website, online forum posts/entries, word processing documents, help desk messages, portable document format (PDF) documents and/or other types of documents. The messages 312 can be provided to the message engine 300 or accessed by a computer program or device that can access the messages.

In some embodiments, the messages 312 can be stored in a database of stored messages 316, which is associated with an email provider, such as Yahoo! Mail®. The database 316 can be any type of database or memory that can store the messages 312 and associated message template information. In some embodiments, message and search information stored in the database 316 can include information associated with a composed or being composed message and information related to a search. In some embodiments, the message information and search information can be stored in association with each other in the database 316 in accordance with the database structure of such database storage. Such search information can include, but is not limited to, the search request/query, a category of search, search preferences, search results and/or the selected search result.

For purposes of the present disclosure, email messages as a whole are discussed within some embodiments; however, it should not be construed to limit the applications of the systems and methods discussed herein. Indeed, while reference is made throughout the instant disclosure to email messages, other forms of electronic documents or transmissions (e.g., Short Message Service (SMS) messages, Multi-media Message Service (MMS) messages, and the like) can be received and/or accessed and processed by the message engine 300 according to the systems and methods discussed herein.

As discussed above, with reference to FIG. 1, the network 314 can be any type of network such as, but not limited to, a wireless network, a local area network (LAN), wide area network (WAN), the Internet, or a combination thereof. The network 314 facilitates connectivity between the messages 312, the message engine 300, and the database of stored resources 316.

The message engine 300 includes a composition module 302, a syntax module 304, search module 306, extraction module 308 and an embed module 310. It should be understood that the engine(s) and modules discussed herein are non-exhaustive, as additional or fewer engines and/or modules may be applicable to the embodiments of the systems and methods discussed. The operations, configurations and functionalities of each module, and their role within embodiments of the present disclosure will be discussed with reference to FIGS. 4A-6.

FIGS. 4A and 4B illustrate processes 400 and 450, respectively, performed in accordance with embodiments of the present disclosure. As discussed above, the present disclosure provides systems and methods for integrating messaging and search capabilities within a messaging platform for seamlessly embedding content within messages during composition of such messages. According to some embodiments, the search for content can be performed over the Internet or other network, in addition to a service provider or platform's hosted content and cloud servers. In some embodiments, the search can be a local search of the user's device, or connected device or medium, such as, but not limited to, a memory stick, flash drive, CD-ROM, and the like, in addition to locally connected devices connected via infrared, Bluetooth®, Wi-Fi, NFC, or other known or to be known connections. The disclosed systems and methods enable a user, from within a messaging application or platform, to perform a search for content, view the results, and select and embed the desired result within the message in a rich format. According to some embodiments, the selection and embedding of content occurs as a “single click”. That is, upon a user selecting content from a search result, the result is automatically embedded in the message. Thus, according to some embodiments, search functionality for searching an array of local and remote sources (e.g., Internet) is integrated within a messaging application.

By way of a non-limiting example, Yahoo! Mail® user Bill can perform a search for content during the composition of a message within the Yahoo! Mail platform or mail program. It should be understood that embodiments of the present disclosure, while discussed in relation to mail applications, can be effectuated via any known or to be known messaging and social applications, programs or platforms. Indeed, as discussed above, while reference to the messages discussed herein are embodied as email messages, the messages according to the present disclosure (and Process 400) can be any type of message, including but not limited to, SMS, MMS messages, as well as social messages communicated through social media platforms and/or other types of content delivery networks.

Continuing with the above example, while user Bill composes the message in the message compose screen, Bill is afforded the ability to perform a search for content. For example, Bill is sending a message to Jane. In the message, Bill has typed text. Bill also desires to include a meme of a “dancing bear”. As understood by those of skill in the art, a meme is a content object related to an activity, concept, catchphrase or piece of media which spreads, often as mimicry, from person to person via the Internet. For example, a meme can include, but is not limited to, a photo related to a popular and trending activity (such as people “planking”), and a short video (e.g., a Vine® or histogram® video) of people dancing.

Conventional techniques would require Bill to switch (or toggle) from his messaging application to a search application to locate the “dancing bear.” After locating the dancing bear in the search application, Bill would then only be able to copy the network address (e.g., URL) of the content item, then switch/toggle back to the messaging application and paste the link in the message. However, the present disclosure enables Bill to search for the “dancing bear” directly from the messaging application.

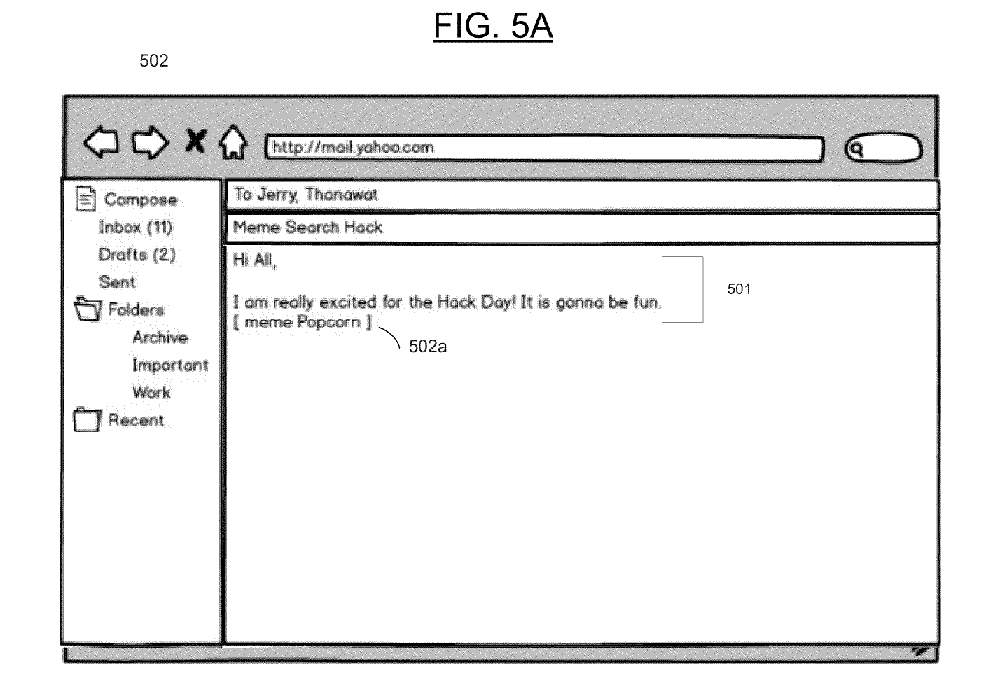

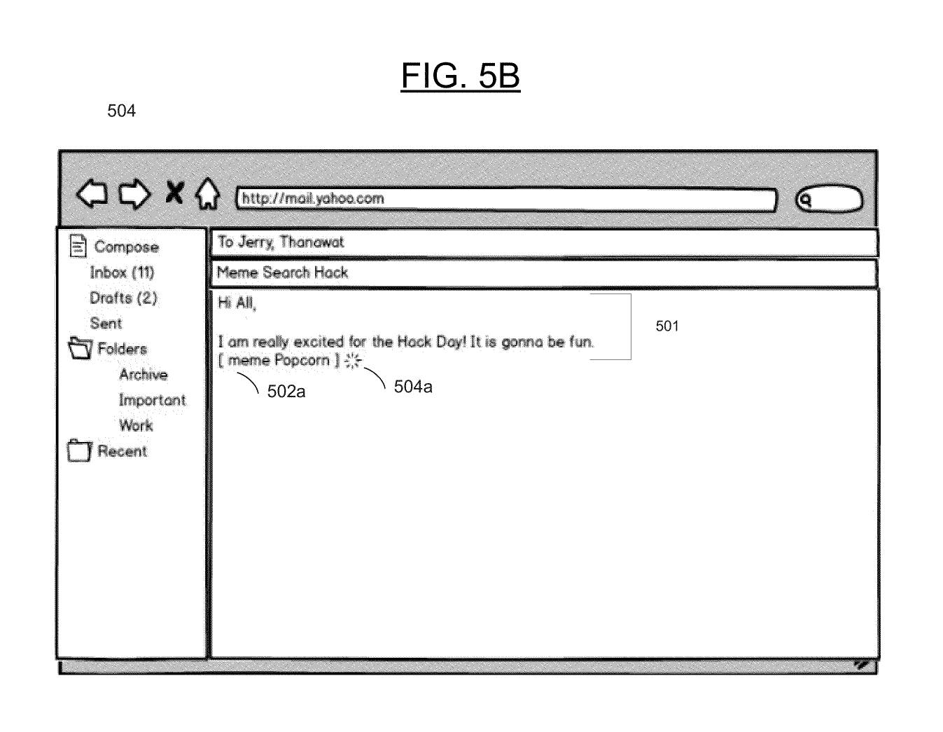

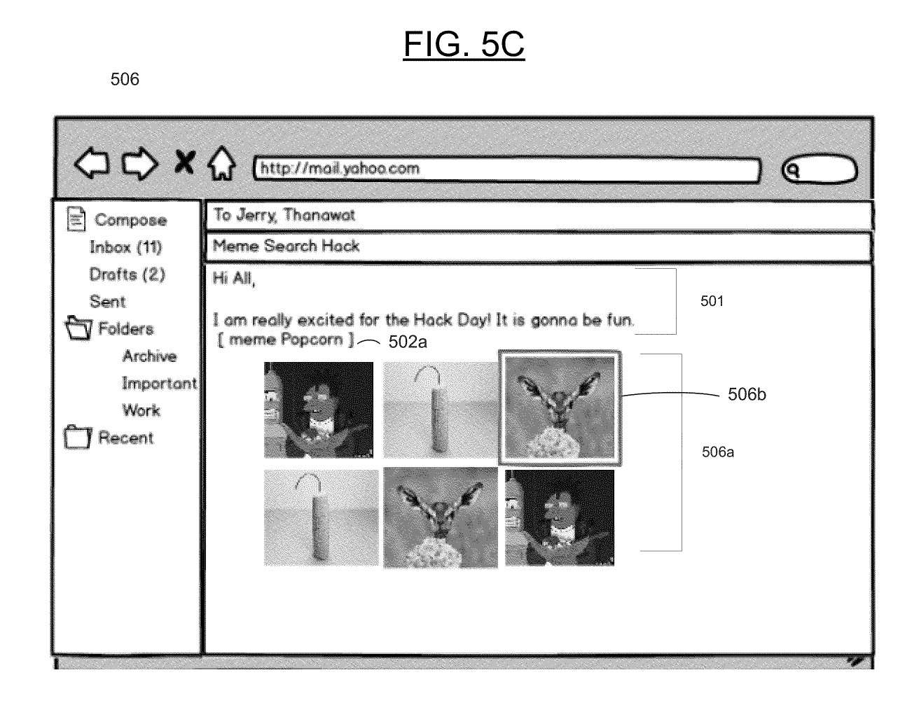

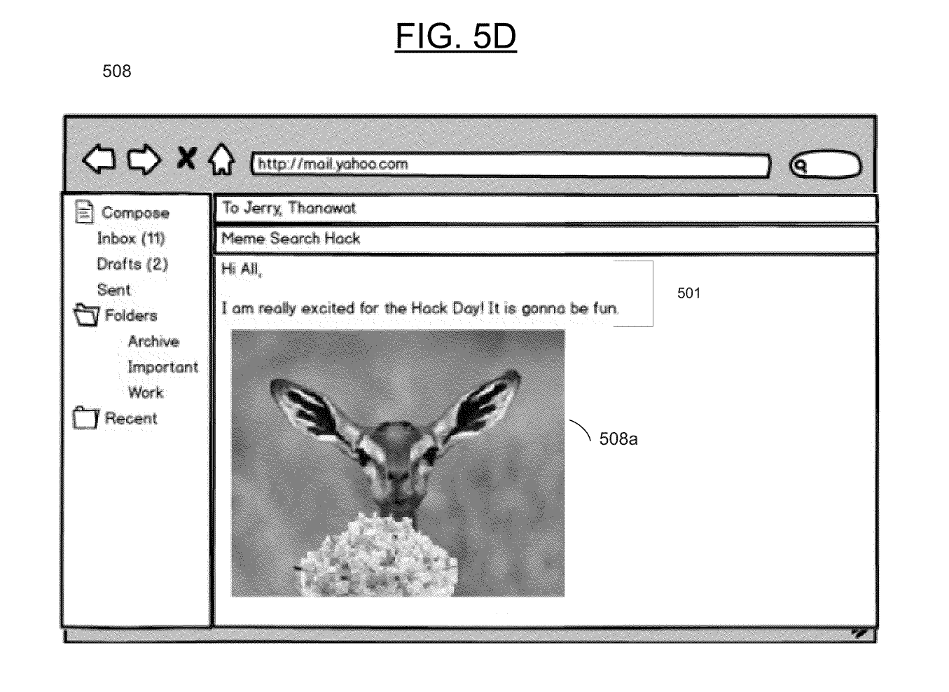

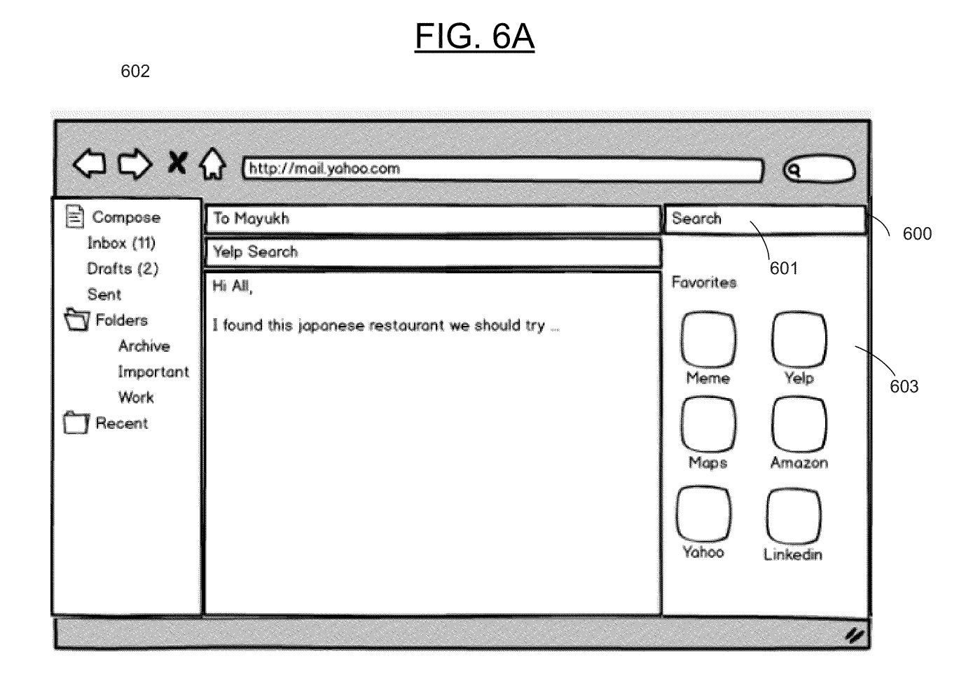

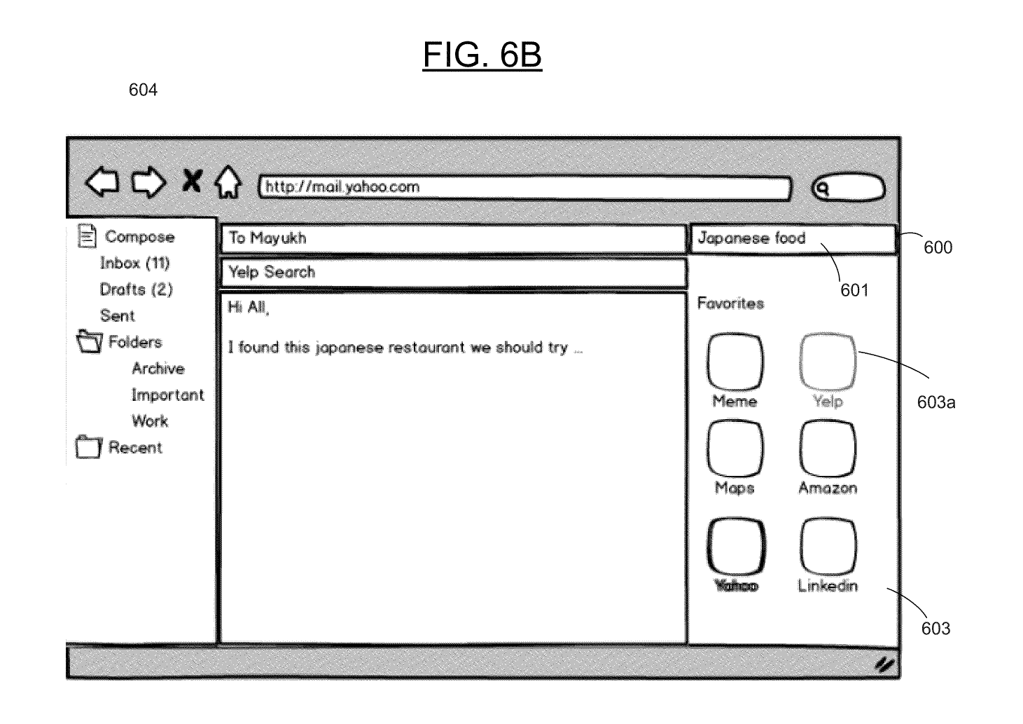

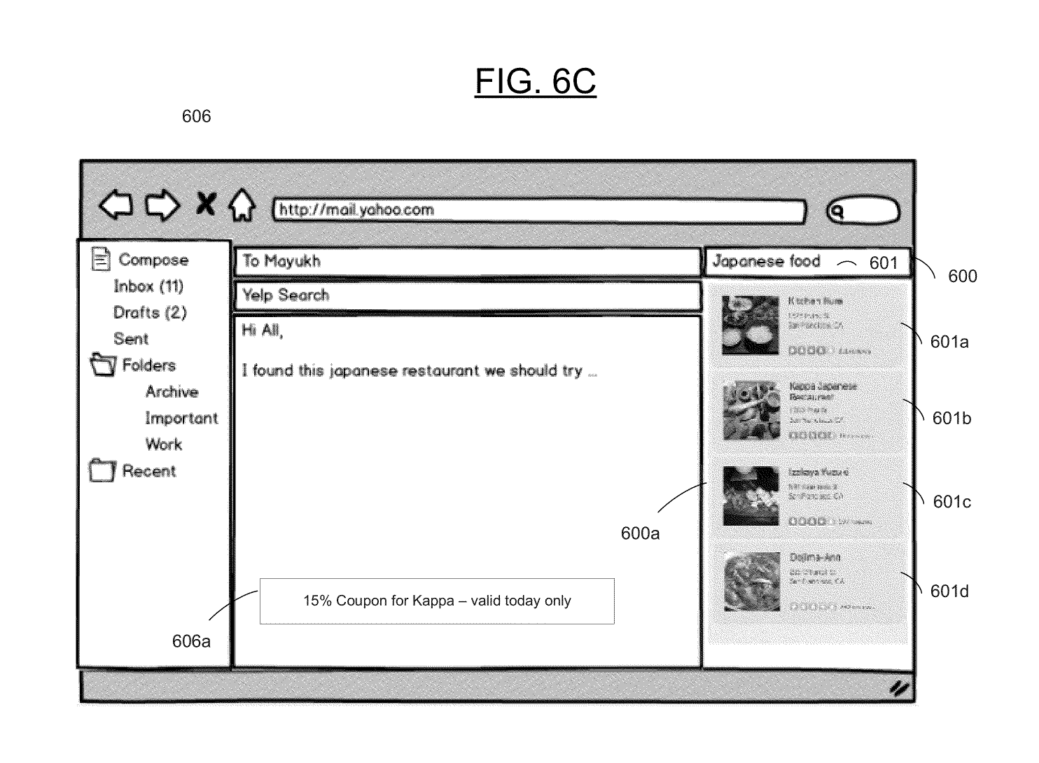

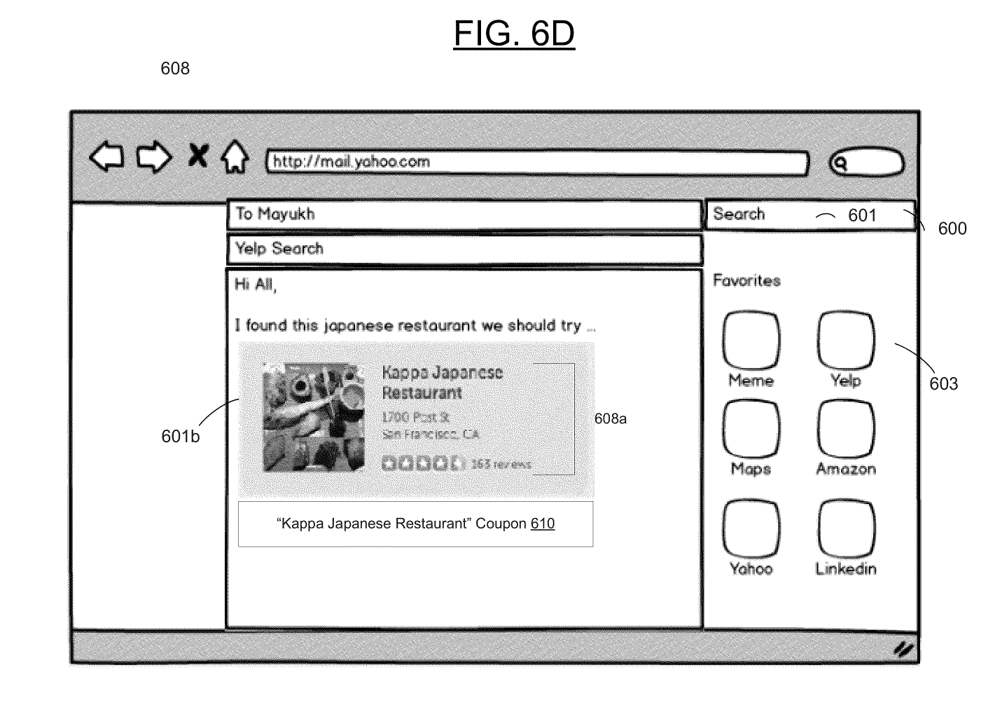

According to some embodiments, as discussed below, Bill can search via a command entry typed directly within the body of the message (or within the message compose window), as in Process 400 and illustrated in FIGS. 5A-5D discussed below. In some embodiments, Bill can search for the “dancing bear” via entry of a search query in a search rail or tile associated with the message compose screen, as provided by the messaging application, as in Process 450 and illustrated in FIGS. 6A-6D discussed below. Therefore, after searching, the results are displayed to Bill within the messaging application. In some embodiments, the results are displayed within the message body (or within a portion of the message compose window), as illustrated in FIGS. 5A-5D; and in some embodiments, the results can be displayed within the search rail of the message compose screen, as illustrated in FIGS. 6A-6D. Bill can then select search result which is then embedded in the message Bill is composing. The embedding, which in some embodiments occurs as a single action correlated with the selection of the search result, is performed in a rich format making it easy for recipient Jane to view upon receiving the message. Therefore, Bill can easily embed the desired content item within the message during composition of the message without having to diverge from the messaging application. Thus, instead of Jane having to click on a link from within the received message and be taken to a separate application in order to view the meme, as with conventional systems, Jane can view the meme upon viewing the message directly from within the message. In other words, upon viewing the message, Jane will be viewing the “dancing bear”, not a link associated with the “dancing bear.”

Turning to FIG. 4A, process 400 involves a user searching for content during composition of a message via an entered command. Process 400 will be discussed in connection with FIGS. 5A-5D, which shows message compose screens/windows 502-508. Process 400 begins at Step 402 when a user composes a message. It should be understood that Step 402 can include an ongoing composition of a message or a composed message, as the following steps of Process 400 are applicable to a message “draft” and a completed message. That is, as evident from the below discussion, a content object can be embedded in a message during composition of a message or after completion of drafting the message, but prior to sending the message. Step 402 can be performed by the composition module 302.

As in Step 402, message composition can be seen in window 502 from FIG. 5A. FIG. 5A shows a message compose window 502 according to an example messaging application which includes a message being composed with text 501. As the message is being composed, or text is being entered into the message (Step 402), the syntax module 304 monitors the user's entries for search queries. Step 404. That is, the entries of the user are analyzed as they are entered, in near real-time (or continuously) to determine if the entry constitutes or includes a search command. A search command, according to some embodiments, can take the form of any known or to be known search operators. For example, a search command can be detected by text or characters being entered within a set of brackets—for example: [meme popcorn], as illustrated by item 502a in FIG. 5A. In another non-limiting example, a search command can also be denoted by the use of a colon operator or hashtag. For example, if user desires to search for mettle's for popcorn, the user can enter “#memepopcorn.” The type of operator should not be construed as limiting to the current disclosure, as any type of known or to be known operator triggering a search is applicable to Process 400.

In Step 406, based on the monitoring occurring in Step 404, a search command is detected. That is, as the user enters the message (Step 402), the user's entries are being continuously analyzed (Step 404) to detect a syntax entry triggering a search (Step 406). in Step 408, a determination is made regarding a category or type of search. The determination in Step 408 is performed based on the detected syntax of the search. From the example provided in FIGS. 5A-5D, the search query is item 502a: [meme popcorn]. The search is for content related to “popcorn” and the category is a “meme.” Thus, the search is for a mettle of popcorn. Steps 404-408 are performed by the syntax module 304.

According to some embodiments, the information derived from Steps 404-408, which includes the requested content and category of the content, can be determined via the syntax module 304 executing in connection with the messaging application. That is, the syntax module 304 can determine such information locally at the device, then communicate the information to a content server 106 (or messaging server 120, for subsequent communication to the content server 106), according to some embodiments. In some embodiments, when the messaging application is executing in a web-based environment or mobile environment, the determinations in Steps 404-408 can be performed via the messaging server 120, where the information derived n such steps is then communicated to a content server for subsequent searching, as discussed below in connection with Step 410.

By way of another example, a search, as per item 502a, could include “#imagebaseball. Here, the category would be for an image and the content would be related to baseball. Thus, the search would equate to images of baseball. Embodiments also exist there category can be based upon the content searched, in that, the most popular category (or categories) associated with such content can be determined as category for Step 408.

In Step 410, a search is initiated based on the detected syntax and determined category. The search module 306 performs Step 410. The processing and initiating of the search is illustrated in window 504 of FIG. 5B, where item 504a illustrates performance of Steps 406-410. According to some embodiments, Step 410 involves querying the Internet for content based on the determined category and detected syntax. As discussed above, the search in Step 410 can be initiated by the device hosting the messaging application, where the information for the search is communicated to a content or other server for searching according to the syntax and category. In some embodiments, when the search information is either communicated to the messaging server, or when the messaging server is hosting a web-based or mobile application, the messaging server can act as a search engine. That is, embodiments exist, as discussed above in FIG. 1, where the messaging server and content server can act as a single server enabling the hosting of the messaging application and execution of a search all from a single network location, a single server. Therefore, Step 410 involves embodiments for initiating a search by communicating the collected information from the above Steps over a network for performance of the search, and Step 410 can involve embodiments for performing the search all from within the messaging application platform. For example, based on the illustrated example in FIGS. 5A-5D for “meme popcorn”, the search module 306, executing on a device or server that is either hosting or connected with the messaging application, can search popular meme sites (such as giphy®, imgur® and the like) for memes related to popcorn. Such sites, referred to as network resources or network accessible resources, are identified and searched based on the determined category. According to some embodiments, such searching can involve an API call identifying the desired content within the query string. For example, the search can be an HTTP REST API call identifying “popcorn” within the query string, whereby an XML/JSON response is received as a search result.

In Step 412, the search results are parsed for source information related to each result. That is, in response to the search (Step 410), the results are parsed in order to extract source information related to each result. Step 412 is performed by the extraction module 308.

According to some embodiments, the results can only include high priority results. For example, the results can be sorted according to some predetermined threshold to include only the “top 10 results” so that only relevant and high notoriety results are displayed to the user. The sorting of the results can be based on page rank per the applicable search engine performing the search, user preferences, virality, or some other known or to be known factor weighing a results display, or some combination thereof The sorting of the results can also, or alternatively, be based upon the space available in (or dimensions of) the message compose window from which the search was triggered.

Some non-limiting examples illustrating parsing of search results and extraction of source information are as follows: for a searched meme, as illustrated in FIGS. 5A-5D, the source information can include a link to the location of the meme results. Thus, if the site imgur is searched, the meme results are parsed to determine the network address and metadata for retrieval of the resultant memes. In another example, if the search is for [yelp McDonalds], where the category is “yelp.com” and the content is “McDonalds”—the search would be performed on the Yelp.com site for reviews of McDonalds. Thus, information extracted from such search could be related to restaurant reviews and ratings. In another example, if a search is for an image or other type of content object, the extracted information could include metadata and/or thumbnail data.

Thus, the parsing of the search results and extraction of information from such results (Step 412) can be based upon the detected category. According to some embodiments, upon performing the search (in Step 410), the results are parsed determine source information (Step 412) that enables presentation of the search results in a viewable manner in a message window, as in Step 414. Step 414 is performed by the embed module 308. In some embodiments, depending on the category of search, the details of the displayed search results can vary. In other words, in some embodiments, the manner of the display of the results may be based upon the type of category being searched. An example of displayed results is illustrated in window 506, where search results for popcorn memos can be seen in item 506a. The results, as illustrated in 506a, can be displayed as an inline result set in a grid view, list view or any other viewing scheme enabling viewing by the composing user. By way of further examples, according to some embodiments, meme and image category results can have a photo or animated photo as the displayed result 506a. In other examples, a news category can have a thumbnail image, title and/or a short snippet displayed. In yet another example, a video category can have a video thumbnail with a playback option displayed.

In Step 416, the selected search result is embedded into the message. Step 416 is performed by the embed module 310. An example of this is illustrated in windows 506 and 508 of FIGS. 5C-5D. Window 506 shows item 506b being selected from results 506a. Upon selection, the image is automatically embedded into the message, as illustrated in window 508 via item 508a. According to some embodiments, the selection and embedding of the content occurs as a single action or “single click” where the embedding occurs as a direct result and instantaneously upon the selection of the desired content. According to some embodiments, the embedding can occur via HTTP, for example, or, if occurring on a mobile device running a messaging application, via any known or to be known mobile technology for formatting and embedding content within an application window.

As illustrated in FIGS. 5C-5D, upon the user selecting item 506b, item 506b is embedded in the message (as item 508a). Thus, according to some embodiments, upon receiving the selection of the content from the results, the source information extracted from Step 412 is read, and such information is embedded into the message. According to some examples as discussed above, depending on the category of the search query (and results), the items embedded into the message can include, but are not limited to, a thumbnail, title, description, summary, video playback, photo slideshow, and the like. For example, as illustrated in FIGS. 5C-5D, the selected meme's (item 506a) source information (e.g., link and metadata) are read, and the associated thumbnail (item 508a) is embedded into the message, as in window 508.

Turning to FIG. 4B, process 450 is discussed in connection with FIGS. 6A-6D, which shows message compose screens/windows 602-608. Process 450 involves composition of a message where searching during such composition is performed via a search rail 600 associated with the message compose screen. It should be understood that while the search rail, as illustrated in FIGS. 6A-6D, is embedded as part of the message compose screen (602-608) of the messaging application, the rail 600 can be any type of rail, tile or window, whereby item 600 can be employed via the application windows 602-608 as part of the windows, adjacent to the windows, overlaying (completely or partially or semi-transparently) the windows or as floating windows. Additionally, embodiments exist where rail 600 can be a tile or portion of each window displayed within a toolbar existing within a messaging application, as an interface object of a user interface area of the application or as a separate toolbar displayed within the interface area of the application.

For purposes of this discussion, the rail 600 is illustrated as a right rail in FIGS. 6A-6D, having positioning to the right of a message body area of an application window; however, based on the above, it should not be so limiting. According to some embodiments, as evident from the below discussion and illustrations in FIGS. 6A-6D, the rail 600 includes a search entry area 601 for performing a search query according to systems and methods discussed herein, and a favorites 603 area. The favorites 603 can be a listing of favorite categories, where a category can be deemed a “favorite” based on behavior of a user, users' of a network as a whole, or some combination thereof For example, if a user searches memes often, the category of search for meme's can be displayed in the favorites 603 portion of the rail 600. Population of the favorites 603 can be based on a user behavior (e.g., search history or message history, for example) or preferences of the user, or according to sponsored content or a sponsored category.

Process 450 begins in a similar manner as process 400, where a user is composing a message, Step 452, and illustrated in window 602, for example. As discussed above, it should be understood that Step 452 can include ongoing composition of a message or a completed message prior to sending. Step 452 is performed by the composition module 302.

In Step 454, the user enters a search query for content. As discussed above, the search query is entered in entry area 601 within rail 600. An example of Step 454 can be seen in window 604, where the search term “Japanese food” is entered in area 601. In Step 456, a determination as to the category for such search is performed. As discussed above, the category of the search can be selected by the user via selection of a category listed in favorites 603. In some embodiments, the category may be determined in accordance with the search query. That is, as illustrated in FIGS. 6A-6B, if the user is searching for “Japanese food,” the user is most likely looking for reviews of restaurants serving such food, and not likely images or videos of such content. Should the latter be assumed the execution by the search module 306, the entry would most likely include a category type in the search query, as is understood by those of skill in the art. The processes occurring in Step 454-456 can be seen as illustrated in window 604 from FIG. 6B.

In Step 458, a search is performed for the search query based on the determined category. Steps 454-458 are performed by the search module 306. The search being performed in Step 458 occurs in a similar manner as discussed above in connection with Step 410 from FIG. 4A. Thus, after receiving the search query (Step 454) and determining the category for the search (Step 456), a search is performed based on the query and category (Step 458). According to some embodiments, Step 458 involves instantaneously querying the Internet for content based on the determined category. For example, based on the illustrated examples FIGS. 6B-6D—for “Japanese food”, the search module 306 can search the Yelp.com website (the category) for Japanese restaurants. In a similar manner as Step 410 discussed above, according to some embodiments, such searching can involve an API call identifying the desired content within the query string. For example, the search can be an HTTP REST API call identifying “Japanese food” within the query string, whereby an XML/JSON response is received from the Yelp site as a search result.

In Step 460, the search results are parsed for source information. Step 460 is performed in a similar manner as Step 412 discussed above. Thus, in response to the search (Step 458), the results are parsed to extract source information related to each result. This is performed by the extraction module 308. Therefore, as discussed above with respect to Step 412 of FIG. 4A, Step 460 can involve deriving source information related to the search results for “Japanese food” on the Yelp website, for example. In Step 462, the search results are displayed, Such display is performed in a similar manner as in Step 414 discussed above. In some embodiments, the derived source information may also be displayed. Thus, according to some embodiments, Step 462's display of the results is illustrated in window 606, where the search results (items 601a-601d, for example) are displayed in a drop-down window portion 600a affiliated with entry area 601 within rail 600.

As discussed above, the number/quantity of listing can be based upon a preference of the system or user, or according to other factors that limit the number of results being displayed. indeed, some embodiments exist where portion 600a is scrollable enabling additional listings up to and including: 600n, for example. By way of non-limiting example, as in window 606, source information for the “Japanese food” search results from the Yelp website can also be displayed, and can include, but is not limited to, each restaurant results' address, reviews or ratings, a thumbnail image and name. It should be understood that embodiments exist where the results could be displayed within the message compose area, as in FIG. 4A and FIGS. 5A-5D, or in a window that is adjacent to, overlaying or associated with the messaging application.

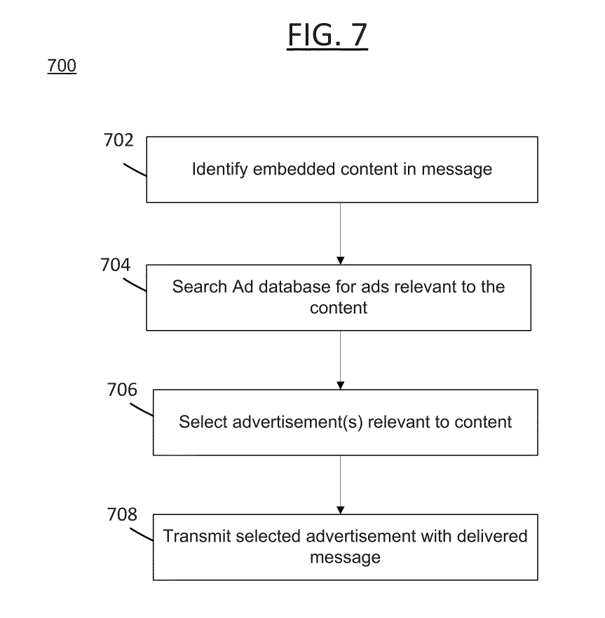

According to some embodiments, an advertisement(s) can also be displayed in connection with the search results, whether the results are displayed within the message body (as discussed in FIG. 4A and illustrated in FIG. 5C) or displayed in the rail 600 (as discussed in FIG. 4B and illustrated in FIG. 6C). That is, upon initiating or performing the search, as discussed above, contextually relevant advertisements can be identified, selected and embedded in a message, as discussed in more detail below with reference to FIG. 7.

According to some embodiments, when search results are displayed in connection with the message application, the results can have affiliated sponsored content and/or a contextually relevant ad. The sponsored content can include, but is not limited to, coupons, deals or other types of advertisements associated with each result. For example, as in FIG. 6C, results 601a-601d can also have associated advertisement displayed. The ads associated with each advertisement can be displayed along with each result, in the message body, or in some embodiments can be displayed in another associated portion of the rail 600, such as another sub-rail portion similar to rail area 600a or a slidesheet or pop-out window. Thus, the ads displayed along with the search results may drive or persuade a user to select a particular result over another result.

For example, as illustrated in FIG. 6C, if a user is searching for “Japanese food” and the results list four restaurants (601a-601d), and one of the restaurants in the search result also has an advertisement 606a for a coupon, the user may be more likely to select the item in the result that is associated with a displayed coupon. As illustrated in window 606 of FIG. 6C, the advertisement 606a states, as a non-limiting example: “15% coupon for Kappa—valid only today.” The advertisement 606a is displayed in the message body, however, as discussed above, this is a non-limiting example, as the advertisement 606a may also be displayed in other associated portions of the window 606. It should be understood that the number of advertisements displayed is not limited to one, as there can be any number of advertisements displayed corresponding to the displayed search results. Indeed, there can also be a number of advertisements listed in connection with one search result, where the ads correspond to differing deals or coupons being offered in association with the result.

Therefore, as discussed above in connection with ad-serving, the provider or service hosting the messaging application can monetize the search features discussed herein, as third parties, businesses, and other types of entities striving for a commercial advantage would be inclined to pay for prioritized placement of their identity and advertisements in search results or sponsorship of their content via the application, since the search terms and/or the selected search result item(s) are highly contextually relevant to the user at the time of message creation.

In Step 464, the selected search result is embedded into the message. Steps 462 and 464 are performed by the embed module 310. An example of Step 464 is illustrated in windows 606 and 608 of FIGS. 6C-6D. Window 608 shows item 601b having been selected from results 600a in window 606. Upon selection, the image is automatically embedded into the message, as illustrated in window 608. According to some embodiments, the selection and embedding of the content occurs as a single action or “single click” where the embedding occurs as a direct result and instantaneously upon the selection of the desired content. According to some embodiments, the embedding can occur via HTTP, for example, or, if occurring on a mobile device running a messaging application, via any known or to be known mobile technology for embedding content within an application window.

According to some embodiments, the selection can involve a drag-and-drop operation by the user, where the user can select a search result and drag it into the message compose area. The embedding performed in Step 464 occurs in a similar manner as the embedding performed in Step 416 discussed above. Thus, for example, as illustrated in FIG. 6D, the embedded result is displayed as a thumbnail (item 601b) and includes the source information of selected result (item 608a) where the source information includes the name of the restaurant, address and ratings, as illustrated in window 608.

According to some embodiments, the embedded result discussed in Step 416 can also include an advertisement 610, as discussed above and discussed in more detail below. That is, an advertisement 610 may also be embedded into the message, where such advertisement 610 may be associated with an advertisement displayed in the search results, as discussed above, or may be selected in connection with which content was embedded, as discussed in more detail below.

According to some embodiments, the command entry discussed in FIG. 4A can effectuate a display of search results in a rail 600, as in FIG. 6C. Thus, upon entry of the search command (i.e., detection of the search syntax as in Step 406), the results could be displayed in a rail 600 as in illustrated in FIG. 6C and discussed in connection with Process 450. Indeed, in some embodiments, the search and results display from Process 450 could be effectuated in a similar manner discussed in Process 400 and illustrated in FIGS. 5A-5D. That is, when a search and category are identified, as in Steps 454-456, the results could be displayed and content embedded in a message in conjunction with Process 400. Therefore, it should be understood that embedding of content in a message can occur through a combination of steps being performed in accordance with a combination of Processes 400 and 450 (and through a combination of windows displayed in FIGS. 5A-5D and 6A-6D, respectively).

FIG. 7 is a work flow 700 of serving relevant advertisements based on the content embedded in a message. Specifically, FIG. 7 illustrates how advertisements are served to a recipients of messages based on the specific content from the messages directed to a recipient. In Step 702, content from a message that was embedded in the message, as discussed above, is identified. That is, the content that was embedded in the message upon composition of the message forms a basis for a context for serving advertisements having a similar context. It should be understood that such content may not be limited to the content of the email's body, for example, in some embodiments, such content can also be based on, but is not limited to, the category of content searched, the search query's terms, the location of the user upon performing the search, the demographic information of the sender and/or recipient, the subject of the message, the sender's identity, the recipient's identity, and the like. Indeed, any and all types of message content, as discussed above, can form the basis for such content. That is, according to some embodiments, the content identified in or associated with a message can be based upon a combination of content. For example, embedded content combined with information derived from the message (e.g., subject line of the message) can be identified, as in Step 702. In some embodiments, the content that was embedded may be weighted differently upon situations where a combination of content is being used.

According to some embodiments, the intent of a user's search can be used as a tool to monetize communications by presenting contextually and temporally relevant search terms to advertisers to bid on the placement in the message. That is, in addition to, or alternative to the content identified in the search, search data including the search terms, metadata of the search and/or search results, and/or other types of data representative of a search query or search result, and the like, may be identified or utilized in Step 702. Therefore, instead of identifying only a particular content item from a message (or search), a user's intent associated with a content type or category can be identified. For example, if a user's search included the term “football” and the user selected the item from the search “NY Giants”, process 700 can utilize the information that the user is not only interested in the “NY Giants” but also that the user is interested in (or has an intent associated with) football general. Therefore, as discussed in below, the advertisement can be focused upon the selected search term, and/or the category or content type associated with the search.

By way of another non-limiting example, in connection with the example from FIGS. 6A-6D, upon the user searching for “Japanese food” and selecting the restaurant Kappa (item 601b), process 700 can utilize the information that the user is not only interested in “Japanese food” but also the restaurant Kappa, and potentially the location of Kappa. Therefore, the advertisement can be focused upon at least one of, Japanese food, the restaurant Kappa, other restaurants within a threshold proximity to Kappa (as the user has expressed an interest in that geographic area), or other closer or geographically related Japanese restaurants, among other types of advertisement factors.

In Step 704, the content (or content data) is communicated (or shared) from the message platform to an advertisement server 130. Upon receipt of the content data, the advertisement server 130 performs a search for a relevant advertisement(s) within an associated advertisement database. The search for an advertisement is based at least on the identification occurring in Step 702, discussed above.

In Step 704, the advertisement server 130 searches the advertisement database for advertisements that are relevant (or associated with or match) the identified content. In Step 706, an advertisement is selected (or retrieved) based on the results of Step 704. In some embodiments, the advertisement can be selected based upon the result of Step 704, and modified to confirm to attributes of the page or inbox upon which the advertisement will be displayed, and/or to the device for which it will be displayed. In some embodiments, as in Step 708, the selected advertisement is shared or communicated via the message platform. That is, in some embodiments, the selected advertisement can be embedded in the message. According to some embodiments, upon a search result being selected, where it is automatically embedded in the message, Process 700 is triggered, whereby upon selection of the advertisement (Step 706), the advertisement is also automatically embedded in the message. In some alternative embodiments, the selected advertisement is sent directly to each user's computing device. Thus, in conjunction with the above discussion, the selected advertisement is shared/communicated upon the message being delivered to the recipient. In some embodiments, the advertisement may also be embedded within the message body. In some embodiments, the message may overlay or partially overlay the message or message body; and in some embodiments, the advertisements may be located adjacent to the message, or within an area of the inbox (or application) receiving and displaying the message and advertisement. It should be understood that all known and to be known methodologies and display set-ups for presenting an advertisement are applicable herein.

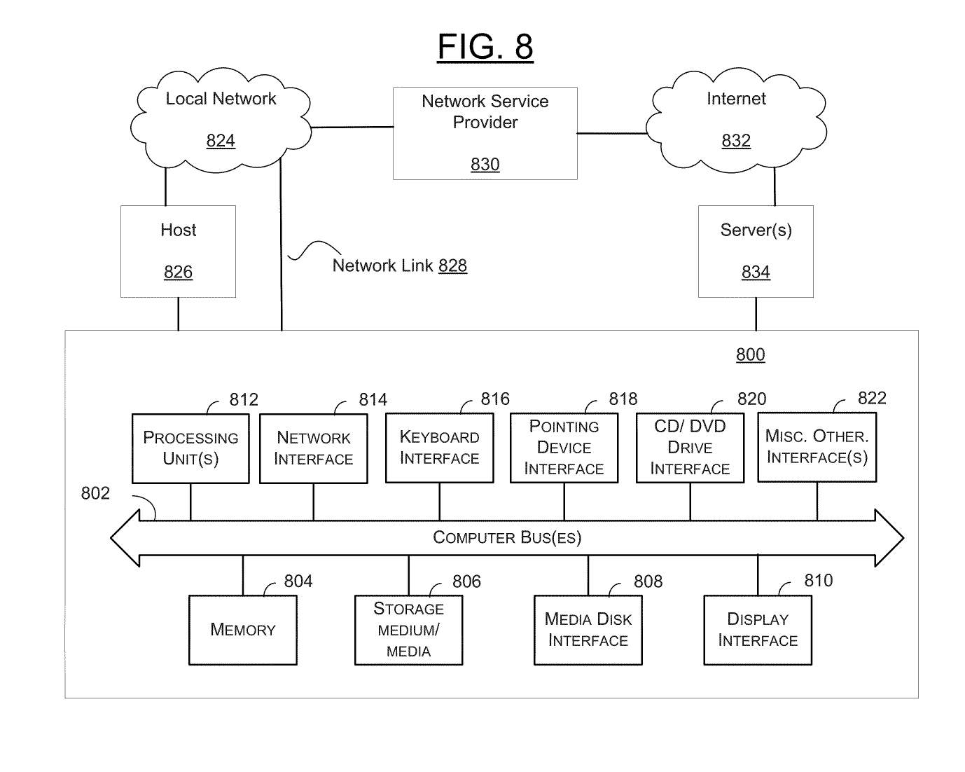

As shown in FIG. 8, internal architecture 800 includes one or more processing units, processors, or processing cores, (also referred to herein as CPUs) 612, which interface with at least one computer bus 802. Also interfacing with computer bus 802 are computer-readable medium, or media, 806, network interface 814, memory 804, e.g., random access memory (RAM), run-time transient memory, read only memory (ROM), media disk drive interface 820 as an interface for a drive that can read and/or write to media including removable media such as floppy, CD-ROM, DVD, media, display interface 810 as interface for a monitor or other display device, keyboard interface 816 as interface for a keyboard, pointing device interface 818 as an interface for a mouse or other pointing device, and miscellaneous other interfaces not shown individually, such as parallel and serial port interfaces and a universal serial bus (USB) interface.

Memory 804 interfaces with computer bus 802 so as to provide information stored in memory 804 to CPU 812 during execution of software programs such as an operating system, application programs, device drivers, and software modules that comprise program code, and/or computer executable process steps, incorporating functionality described herein, e.g., one or more of process flows described herein. CPU 812 first loads computer executable process steps from storage, e.g., memory 804, computer readable storage medium/media 806, removable media drive, and/or other storage device, CPU 812 can then execute the stored process steps in order to execute the loaded computer-executable process steps. Stored data, e.g., data stored by a storage device, can be accessed by CPU 812 during the execution of computer-executable process steps.

Persistent storage, e.g., medium/media 806, can be used to store an operating system and one or more application programs. Persistent storage can also be used to store device drivers, such as one or more of a digital camera driver, monitor driver, printer driver, scanner driver, or other device drivers, web pages, content files, playlists and other files, Persistent storage can further include program modules and data files used to implement one or more embodiments of the present disclosure, e.g., listing selection module(s), targeting information collection module(s), and listing notification module(s), the functionality and use of which in the implementation of the present disclosure are discussed in detail herein.

Network link 828 typically provides information communication using transmission media through one or more networks to other devices that use or process the information. For example, network link 828 may provide a connection through local network 824 to a host computer 826 or to equipment operated by a Network or Internet Service Provider (ISP) 830. ISP equipment in turn provides data communication services through the public, worldwide packet-switching communication network of networks now commonly referred to as the Internet 832.

A computer called a server host 834 connected to the Internet 832 hosts a process that provides a service in response to information received over the Internet 832. For example, server host 834 hosts a process that provides information representing video data for presentation at display 810. It is contemplated that the components of system 800 can be deployed in various configurations within other computer systems, e.g., host and server.

At least some embodiments of the present disclosure are related to the use of computer system 800 for implementing some or all of the techniques described herein. According to one embodiment, those techniques are performed by computer system 800 in response to processing unit 812 executing one or more sequences of one or more processor instructions contained in memory 804. Such instructions, also called computer instructions, software and program code, may be read into memory 804 from another computer-readable medium 806 such as storage device or network link. Execution of the sequences of instructions contained in memory 804 causes processing unit 812 to perform one or more of the method steps described herein. In alternative embodiments, hardware, such as ASIC, may be used in place of or in combination with software. Thus, embodiments of the present disclosure are not limited to any specific combination of hardware and software, unless otherwise explicitly stated herein.

The signals transmitted over network link and other networks through communications interface, carry information to and from computer system 800, Computer system 800 can send and receive information, including program code, through the networks, among others, through network link and communications interface. In an example using the Internet, a server host transmits program code for a particular application, requested by a message sent from computer, through Internet, ISP equipment, local network and communications interface. The received code may be executed by processor 802 as it is received, or may be stored in memory 804 or in storage device or other non-volatile storage for later execution, or both.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “subscriber” “consumer” or “customer” should be understood to refer to a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving, at a computing device, message input from a user in a messaging application, said message input corresponding to composition of a message via the messaging application;
detecting, via the computing device, a search query from said message input, said search query comprising a search request;
determining, via the computing device, a category associated with said search;
searching, via the computing device, for content on a network based on said search query said search initiated by the messaging application to search a network accessible resource associated with said category;
displaying, via the computing device, search results within said messaging application in association with said message;
receiving, at the computing device, a user selection of a result from said search results; and
embedding, via the computing device, said selected result in said message, said embedding occurring automatically upon said selection by the user.

2. The method of claim 1, further comprising:
parsing, via the computing device, said search results, said parsing comprising extracting information from each result in said search results based on the determined category.

3. The method of claim 2, wherein aid embedded result comprises said extracted information associated with the selected result.

4. The method of claim 1, further comprising:
communicating, via the computing device, said message with said embedded result.

5. The method of claim 1, further comprising:
monitoring, via the computing device, said message input for a syntax entry associated with a search command, wherein said determined category is based upon said syntax entry; and
upon detection of said syntax entry, performing said searching.

6. The method of claim 5, wherein said syntax entry comprises a search operator for triggering a search affiliated API call of the network resource associated with the category.

7. The method of claim 1, wherein said message entry comprises a search input, said search input received in a search portion of said messaging application, said search input comprising said search query.

8. The method of claim 7, wherein said message entry further comprises a category input associated with said search input, said category input received in a category portion of said messaging application that is associated with said search portion, wherein said category is based on said category input.

9. The method of claim 1, wherein said message input comprises text input into a body of the message.

10. The method of claim 1, said displayed search results are displayed inline within a body of the message.

11. The method of claim 1, wherein said displayed search results are displayed in a search results portion of a message application, said search results portion associated with said message.

12. The method of claim 1, wherein said category corresponds to a type of content associated with said network resource.

13. The method of claim 1, further comprising:
causing the search query to be communicated to an ad platform;
receiving an ad result from the ad platform comprising an advertise associated with a context of the search query; and
causing the advertisement to be associated with the message.

14. The method of claim 1, further comprising:
causing data representative of the search results to be communicated to an ad platform;
receiving an ad result from the ad platform for at least one search result, said ad result comprising an advertisement associated with a context of the at least one search result; and
causing the advertisement to be associated with the message.

15. A non-transitory computer-readable storage medium tangibly encoded with computer-executable instructions, that when executed by a processor associated with a computing device, performs a method comprising:
receiving message input from a user in a messaging application, said message input corresponding to composition of a message via the messaging application;
detecting a search query from said message input, said search query comprising a search request;
determining a category associated with said search;
searching for content on a network based on said search query, said search initiated by the messaging application to search a network accessible resource associated with said category;
displaying search results within said messaging application in association with said message;
receiving a user selection of a result from said search results;
embedding said selected result in said message, said embedding occurring automatically upon said selection by the user; and
communicating said message with said embedded result.

16. The non-transitory computer-readable storage medium of claim 15, further comprising:
parsing, via the computing device, said search results, said parsing comprising extracting information from each result in said search results based on the determined category, wherein said embedded result comprises said extracted information associated with the selected result.

17. The no transitory computer-readable storage medium of claim 15, further comprising:
monitoring, via the computing device, said message input for a syntax entry associated with a search command, said syntax entry comprises a search operator, wherein said determined category is based upon said syntax entry; and
upon detection of said syntax entry, performing said searching.

18. The non-transitory computer-readable storage medium of claim 15, wherein said message entry comprises a search input, said search input received in a search portion of said messaging application, said search input comprising said search query, wherein said message entry further comprises a category input associated with said search input, said category input received in a category portion of said messaging application that is associated with said search portion, wherein said category is based on said category input.

19. The non-transitory computer-readable storage medium of claim 15, wherein said displayed search results are displayed inline within a body of the message.

20. The non-transitory computer-readable storage medium of claim 15, wherein said displayed search results are displayed in a search results portion of a message application, said search results portion associated with said message.

21. A system comprising:
at least one computing device comprising:
memory storing computer-executable instructions; and
one or more processors for executing said computer-executable instructions for:
receiving message input from a user in a messaging application, said message input corresponding to composition of a message via the messaging application;
detecting a search query from said message input, said search query comprising a search request;
determining a category associated with said search;
searching for content on a network based on said search query, said search initiated by the messaging application to search a network accessible resource associated with said category;
displaying search results within said messaging application in association with said message;
receiving a user selection of a result from said search results; and
embedding said selected result in said message, said embedding occurring automatically upon said selection by the user.

22. The system of claim 21, further comprising:
parsing said search results, said parsing comprising extracting information from each result in said search results based on the determined category, wherein said embedded result comprises said extracted information associated with the selected result; and
communicating said message with said embedded result.

23. A method comprising:
receiving, at a computing device, a search request from a user upon said user composing a message in a messaging application, said search request identifying a content type and category associated with a network accessible resource;
causing, via the computing device, the network accessible resource to be searched based on said search request;
causing, via the computing device, search results to be displayed to the user within the messaging application displayed on the user's device;
receiving, at the computing device, a selection from the user of a result from said search results;
causing, via the computing device, an advertisement platform to be searched based on the selected result;
receiving, at the computing device, an advertisement associated with said selected result; and
causing, via the computing device, said selected result and the advertisement to be displayed to the user within the messaging application displayed on the user device.

24. A method comprising:
receiving, at a computing device, a search request from a user upon said user composing a message in a messaging application concurrently displayed on a user device, said search request identifying a content type and category locatable on a network accessible resource;
causing, via the computing device, a search for a search result and an advertisement based on the search request,
receiving, at the computing device, said search result and said advertisement; and
causing, via the computing device, the search result and the advertisement to be displayed to the user within the messaging application displayed on the user device.

25. The method of claim 24, wherein said causing step comprises said search for the search result being directed to the network accessible resource, and comprises said search for the advertisement being directed to an advertisement platform associated with the network accessible resource.
